(19) United States
(12) Patent Application Publication
(10) Pub. No.: US 2005/0019534 A1
(43) Pub. Date: Jan. 27, 2005

(54) Method for producing a hybrid product composed of several wiring planes, as well as a sensor or evaluation circuit and a control device with hybrid product produced by the inventive method

(76) Inventors: Walter Roethlingshoefer, Reutlingen (DE); Mark Leverkoehne, Stuttgart (DE)

Correspondence Address: STRIKER, STRIKER & STENBY, 103 East Neck Road, Huntington, NY, 11743, US

(21) Appl. No.: 10/890,589

(22) Filed: Jul. 14, 2004

(30) Foreign Application Priority Data
Jul. 23, 2003 (DE) 103 33 439.4

(51) Int. Cl. B32B 3/00

(52) U.S. Cl. 428/209; 427/123; 427/383.1; 427/404

(57) ABSTRACT

A method of producing a hybrid product composed of a plurality of wiring planes includes printing a plurality of wiring planes with a homogenous metallization base material, performing at least one corresponding sintering step for fixing the metallization base material, and homogeneously chemically coating of freely located sintered metallization base material with at least one coating material; and also a sensor circuit or an evaluating circuit for a sensor as well as a control device are proposed with the hybrid product produced in accordance with the method.

### BACKGROUND OF THE INVENTION

The present invention relates to a method of producing a hybrid product composed of a plurality of wiring planes, as well as to a sensor circuit and control device with a hybrid product produced in accordance with the inventive method.

In present standard hybrid types, various metallization such as for example silver Ag, silver palladium AgPd, silver platinum AgPt or gold Au are used on various substrate materials, for example aluminum oxide Al₂O₃. These various metallization materials cover correspondingly predetermined limited boundaries functions of the corresponding metallizations. For example pure silver Ag is used preferably for a favorable and high current wiring.

Pure silver however has the disadvantage that due to possible corrosion and electromigration of the silver wiring, it can not be used for thin wire bond pads and thick wire bond pads or solder pads. Instead, a pure gold is preferably suitable for thin wire bond pad and silver palladium is preferably suitable for thick wire bond pad or solder pads.

In the prior art, in each of the wiring planes which are separated from one another for example by isolation glass layers, for example three different metallizations or metallization materials are sieve printed and each separately burnt or sintered.

FIG. 1 shows a hybrid product 1 which is produced in accordance with a method of the prior art. It can be seen that various metallization materials for example a first metallization material 4 for example silver and a second metallization material 5, for example silver palladium, are used in both wiring planes 2 and 3 as the metallizations.

A further disadvantage of the solution proposed in the prior art can be clearly seen from FIG. 1, and it resides in that the freely located silver 4 after the end of the method steps must be protected with an insulating material or a cover material, for example a cover glass 7, from outer environmental actions such as moisture, dirt, etc. Thereby an additional method step is needed, which is connected with additional costs.

A further disadvantage, as can be clearly seen from FIG. 1, resides in that several resistors 12 are pressed in the recesses of the previously printed layers. As a result, pronounced topography-effects are produced, which, in particular in the case of small resistance surfaces, lead to difficulties in obtaining the proper resistance values and thereby to an increased reject.

### SUMMARY OF THE INVENTION

Accordingly, it is an object of the present invention to provide a method of producing a hybrid product, as well as a sensor circuit and a control device with rapid product produced by the inventive method, which avoid the disadvantages of the prior art.

In keeping these objects and with others which will become apparent hereinafter, one feature of the present invention resides, briefly stated, in a method of producing a hybrid product composed of a plurality of wiring planes, comprising the steps of printing a plurality of wiring planes with a homogenous metallization base material; performing at least one corresponding sintering step for fixing the metallization base material; and homogeneously chemically coating of freely located sintered metallization base material with at least one coating material.

When the method is performed in accordance with the present invention, it has the advantage that due to the use of a chemical coating process in a standard hybrid region, a homogenous metallization is provided in several wiring planes, which performs different functions, for example thin wire bonding, thick wire bonding, gluing, soldering, etc., and in addition has a good corrosion and migration protection.

A base material is Ag so that AgPd, Ag, Pt or Au material costs in the prior art can be saved. In addition, the additional cover glass is dispensed with, and thereby an additional method step and an additional cost can be saved as well. Furthermore, the resistances to be provided can be printed before an application of corresponding insulation materials or dielectric materials, so that topography effects can be avoided. Due to the homogenous metallization materials, various sieve printing steps or sintering steps used in the prior art can be dispensed with and replaced with a homogenous sieve printing step or sintering step. Thereby significant material cost and labor cost can be saved.

The inventive method provides the above mentioned advantages because the following steps are used during the manufacture of a hybrid product composed of several wiring planes: printing of the several wiring planes with a homogenous metallization base material; performing at least one sintering step for fixing the metallization base material; and homogenous chemically coating the freely located burnt metallization base material with at least one coating material layer.

With the present invention, a sensor arrangement is also proposed which uses a hybrid product, wherein the hybrid product is is produced by the inventive method.

In accordance with the present invention, also a control device is proposed with a hybrid product, wherein the hybrid product is produced in accordance with the inventive method.

In accordance with a preferable embodiment of the present invention, as a homogenous metallization base material, pure silver is utilized. Pure silver is especially cost favorable and has good thermal and electrical conductivities.

In accordance with still a further preferable embodiment of the present invention, the silver is printed with a sieve-printing process on several wiring planes. This is especially advantageous that because of the homogenous metallization material, namely silver, a homogenous sieve printing process is sufficient.

Preferably, as a coating materials such materials are used which during a chemical coating process cover only the metallization base material and do not cover corresponding insulation materials or dielectric materials. Thereby it is guaranteed that only the metallization obtains a corresponding coating.

In particular, nickel, palladium, and gold are used as a coating material. Preferably a coating is composed of three layer which are superimposed over one another. The lowermost layer is for example nickel, the medium layer is for example palladium, and the uppermost layer is for example gold.

In accordance with a further preferable embodiment of the invention, resistances for preventing of topography effects are printed before a formation of insulation layers or dielectric layers.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a cross-section of a hybrid product produced in accordance with a prior art method;

FIG. 2 is a view showing a cross-section of a hybrid product after printing of wiring planes with a homogenous metallization base material in accordance with one embodiment of the present invention;

FIG. 3 is a view showing a cross-section of a hybrid product after a homogenous chemical coating of a freely-located metallization base material in accordance with one embodiment of the present invention; and

FIG. 4 is an enlarged view of a portion A in FIG. 1.

### DESCRIPTION OF THE PREFERRED EMBODIMENTS

A cross-section of a hybrid product 1 in a certain method condition of the inventive manufacturing method is shown in FIG. 2. In various figures, identical or functionally identical components are identified with the same reference numerals. On a substrate 11 composed for example of Al₂O₃ ceramic substrate, a first wiring plane 2 is provided. This wiring plane 2 is composed of different regions of a metallization layer. In the present example it is composed of the metallization-base material silver. Pure silver 4 is especially suitable since it is cost favorable and has a good thermal and electrical conductivity. Pure silver is printed for example with a thickness of 10 μm to 15 μm by means of a sieve printing process on the substrate 11. For fixing of the silver material 4 it is burnt or sintered on the substrate 11.

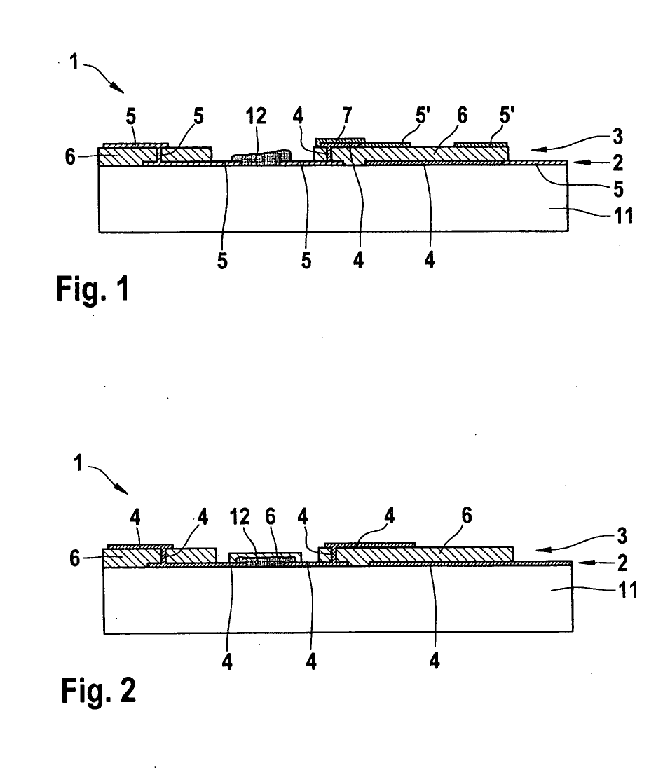

Subsequently resistances 12 can be printed. This is especially advantageous since during the printing of the resistances, no additional layers, such as for example insulation layers or dielectric layers, are available outside of the already printed silver layer 4 and can disturb the printing process. In addition the silver layer 4 with approximately 10 μm to 15 μm is relatively flat and does not hinder the printing of the resistances 12. Thereby the resistances 12 can be printed without topography effects, when compared with the prior art solution shown in FIG. 1.

In a next step, an insulation material 6, for exactly an insulation glass, is placed over the corresponding resistances 12 and on predetermined regions of the silver layers 4, for example by a sieve printing technique. The first insulating layer in addition serves for covering of the resistance 12 so that only the silver layers 4 and the insulation layers 6 are subjected to subsequent chemical processes.

In a next method step, for example the previously used methalization base material, for example silver 4, is applied for example by means of sieve printing technique on predetermined regions of an insulation layer 6 in the upper wiring plane 3. For fixing of the metallization material (silver), it is again sintered. As mentioned above, pure silver is used, which provides the above mentioned advantages.

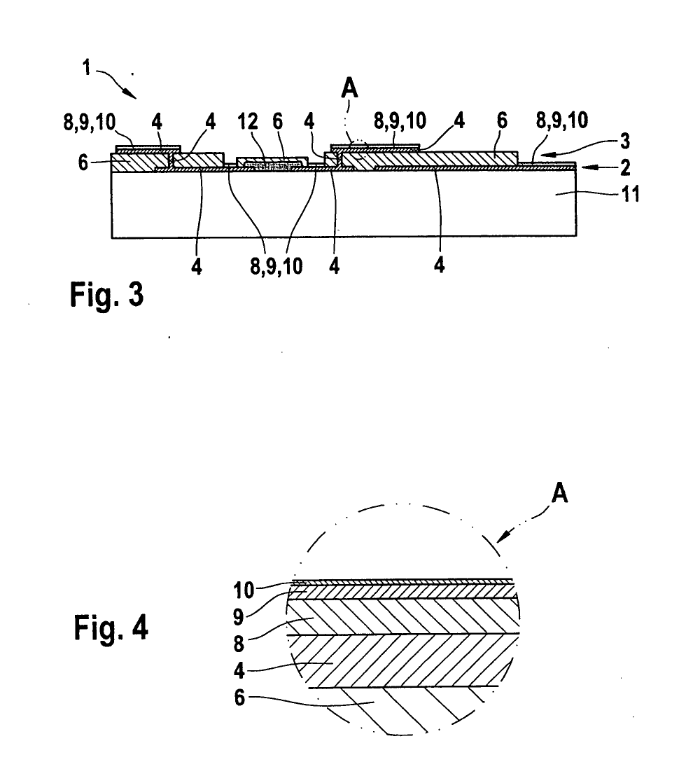

Reference is now made to FIGS. 3 and 4. In a subsequent method step for example three superposed coating materials 8, 9, 10 are applied on all freely located silver layers 4 in the wiring planes 2 and 3. FIG. 3 shows a cross-section of an inventive hybrid product 1 in accordance with one embodiment after an application of one or several coating materials 8, 9, and 10. FIG. 4 shows an enlarged view of the portion A in FIG. 3.

A first coating material 8 for example nickel, a second coating material 9, for example palladium, and a third coating material 10, for example gold, are applied one after the other preferably by a chemical coating process, in layer which are located in one another on all freely located metallization layers, for example silver 4, to form wiring planes 2 and 3 (so-called plating technique). The surface of the hybrid product 1 passes through several successive cleaning and coating baths. A predetermined coating is performed in a corresponding bath by a corresponding material 8, 9 and 10 on the silver layer 4. The thickness of the corresponding coating 8, 9 or 10 depends on the exposure time and adjusted parameters in the corresponding cleaning bath. For example, with a predetermined bath time, a nickel coating of approximately 5 μm, subsequently in a further bath a palladium coating of approximately 0.1 μm, and thereafter in a further bath a gold coating of approximately 30 nm-40 nm are formed. In accordance with the present embodiment, these three coatings 8, 9 and 10 form a homogenous joint coating of the freely located silver layers 4.

With the use of this chemical coating processes, the number of different metallization pastes and lappings, as well as the number of process steps can be significantly reduced. The coatings 8, 9 and 10 are selected preferably so that they are formed on the freely located silver layers 4, and not on corresponding insulation layers or dielectric layers 6.

A substantial advantage of the present invention is that before the chemical coating, i.e. before an application of the layers 8, 9, and 10, the metallizations 4 are already burnt or sintered. Thereby no further sintering steps are needed, which can negatively affect in some cases the coatings 8, 9, 10 with respect to their functions.

The hybrid products produced in accordance with the inventive method, can be utilized in sensor circuits, evaluating circuits for sensors, or in control devices. However, other areas of use are contemplated as well.

The present invention is illustrated by preferably embodiments. However, it is not limited by these embodiments, but instead it can be modified in many ways, for example instead of the metallization base material silver, other metallization base materials, such as for example copper can be utilized. Similarly the above mentioned materials such as for example the coating materials 8, 9 and 10 can be replaced with other materials, which have similar or expanded properties and/or functions.

It will be understood that each of the elements described above, or two or more together, may also find a useful application in other types of constructions differing from the types described above.

While the invention has been illustrated and described as embodied in method for producing a hybrid product composed of several wiring planes, as well as a sensor circuit or evaluation circuit and a control device with hybrid product produced by the inventive method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method of producing a hybrid product composed of a plurality of wiring planes, comprising the steps of printing a plurality of wiring planes with a homogenous metallization base material; performing at least one corresponding sintering step for fixing the metallization base material; and homogeneously chemically coating of freely located sintered metallization base material with at least one coating material.

2. A method as defined in claim 1; and further comprising using pure silver as the homogenous metallization material.

3. A method as defined in claim 2; and further comprising applying the pure silver on a plurality of the wiring planes by a sieve printing process.

4. A method as defined in claim 1; and further comprising using as a coating material a material which provides during a chemical coating process a coating only of the metallization base material and not of corresponding insulation materials or dielectric materials.

5. A method as defined in claim 1; and further comprising using nickel as the coating material.

6. A method as defined in claim 1; and further comprising using palladium as the coating material.

7. A method as defined in claim 1; and further comprising using gold as the coating material.

8. A method as defined in claim 1; and further comprising forming a nickel layer, a palladium layer, and a gold layer one after the other on the metallization base material.

9. A method as defined in claim 1; and further comprising providing resistances before an application of the insulation layers or dielectric layers, for preventing topography effects.

10. A method as defined in claim 1, wherein said providing includes applying the resistances prior to the application of insulation layers or dielectric layers.

11. A method as defined in claim 1, wherein said providing includes printing the resistances prior to the application of insulation layers or dielectric layers.

12. A method as defined in claim 9; and further comprising covering elements selected from the group consisting of the resistances, the layers applied on one another, and both, by a covering material so that they are not chemically coated and not directly exposed to used bath as during the chemical coating.

13. A circuit selected from the group consisting of a sensor circuit and evaluating circuit for a sensor with a hybrid product, wherein the hybrid product is produced by a method comprising the steps of printing a plurality of wiring planes with a homogenous metallization base material; performing at least one corresponding sintering step for fixing the metallization base material; and homogeneously chemically coating of freely located sintered metallization base material with at least one coating material.

14. A control device, comprising a hybrid product which is produced by a method comprising the steps of printing a plurality of wiring planes with a homogenous metallization based material; performing at least one corresponding sintering step for fixing the metallization base material; and homogeneously chemically coating of freely located sintered metallization base material with at least one coating material.
